(19) United States
(12) Patent Application Publication
(10) Pub. No.: US 2006/0093895 A1
(43) Pub. Date: May 4, 2006

(54) Rechargeable battery

(75) Inventor: Hong-Sup Lim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/246,257

(22) Filed: Oct. 11, 2005

(30) Foreign Application Priority Data
Oct. 28, 2004 (KR) 10-2004-0086611

(51) Int. Cl. H01M 2/12; H01M 2/08

(52) U.S. Cl. 429/53; 429/61; 429/54; 429/185

(57) ABSTRACT

A rechargeable battery includes an electrode assembly comprising a positive electrode, a negative electrode, and a separator interposed in between the electrodes, a case that houses the electrode assembly, and a unidirectional valve assembly that is installed at a side of the case, is connected through with the inside of the case, and releases gas only from the inside to the outside.

### CROSS-REFERENCE TO RELATED APPLICATION

This application claims priority to and the benefit of Korean Patent Application No. 10-2004-0086611, filed on Oct. 28, 2004, which is hereby incorporated by reference for all purposes as if fully set forth herein.

### BACKGROUND OF THE INVENTION

1. Field of the Invention

The present invention relates to a rechargeable battery with an extended lifespan by maintaining a pressure inside a case at a predetermined level.

2. Description of the Background

Generally, rechargeable batteries can be repeatedly charged and discharged unlike nonrechargeable batteries which cannot be recharged. High power rechargeable batteries that have a high energy density and use a non-aqueous electrolyte have recently been developed. Low-capacity batteries that include a single battery cell that is packaged in the form of a pack are used as a power source for small portable electronic devices such as mobile phones, laptop computers, and camcorders. Large batteries that include a plurality of battery cells that are connected together are used as a power source to drive the motors of machines that require a significant amount of electric power such as electric vehicles.

Rechargeable batteries are classified into categories according to their external shape such as cylinders, rectangular-boxes, or pouches.

Rechargeable batteries generally include an electrode assembly that may be formed by winding a sheet-shaped positive electrode and a negative electrode with a separator serving as an insulator. Alternatively, the electrode assembly may be formed by stacking a positive electrode, a negative electrode, and an insulating separator in a multiple layers. The electrode assembly may be inserted in a case that is closed with a cap assembly that has an external terminal.

However, gas is generated by chemical reactions that occur inside a rechargeable battery and may cause an explosion and combustion if the internal pressure increases beyond a predetermined level.

Japanese Patent Laid-Open Publication No. 2000-223102 discloses rechargeable batteries with a pressure-releasing valve that prevents an explosion in case of a battery malfunction. Here, the pressure-releasing valve is situated in the cap plate which is installed into the case and ruptures at a predetermined pressure.

However, a problem with the above pressure-releasing valve is that once the pressure-releasing valve ruptures beyond its level of sustainable pressure, the rechargeable batteries are ruined due to air and moisture inflow from the outside through the opening. Accordingly, the rechargeable battery loses its air-tight property and can no longer function properly.

In general, this problem leads to a shorter battery lifespan. In particular, when the rechargeable batteries have a large power storage capacity for driving motors such as those in electric vacuums, electric scooters, electric vehicles, or hybrid electric automobiles, larger energy output and larger power storage capacity are required. Therefore, as the capacity of the batteries increases, so does the change in internal pressure. When the pressure-releasing valve ruptures following a change in internal pressure, sufficient high energy output is not obtained.

### SUMMARY OF THE INVENTION

The present invention provides a rechargeable battery that maintains the internal pressure at a predetermined level by improving the structure of a safety device.

Additional features of the invention will be set forth in the description which follows, and in part will be apparent from the description, or may be learned by practice of the invention.

The present invention discloses a rechargeable battery that includes a safety valve assembly that is housed in a cap assembly and has a unidirectional structure, so that it may open at a predetermined pressure level and release gas to the outside. The battery further includes an electrode assembly comprising a positive electrode, a negative electrode, a separator interposed in between the electrodes, and a case for housing the electrode assembly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram of a rechargeable battery according to a first embodiment of the present invention.

FIG. 2 is a schematic cross-sectional view of a rechargeable battery according to a first embodiment of the present invention.

FIG. 3 is a cross-sectional view of a rechargeable battery according to a second embodiment of the present invention.

FIG. 4 is a cross-sectional view of a safety valve assembly of a rechargeable battery according to a second embodiment of the present invention.

FIG. 5 is a cross-sectional view of a rechargeable battery according to a third embodiment of the present invention.

FIG. 6 is a cross-sectional view of a safety valve assembly of a rechargeable battery according to a fourth embodiment of the present invention.

FIG. 7 is a cross-sectional view of a safety valve assembly of a rechargeable battery according to a fifth embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

A rechargeable battery of the present invention may release the gas that is generated from within the battery, may keep the battery air-tight, and may maintain the internal pressure of the battery at an optimal level. In addition, it maintains the stability of the battery, prevents deterioration of its performance, and prolongs its lifespan.

The rechargeable batteries or battery modules of the present invention may be useful as power sources for high power electric devices that are driven by motors such as electric vehicles, hybrid electric vehicles, wireless vacuum cleaners, motorbikes, motor scooters, and the like.

FIG. 1 is a schematic diagram of a rechargeable battery according to a first embodiment of the present invention.

According to FIG. 1, a rechargeable battery 10 of the present invention includes a battery part 15 that generates electricity, a communication part 16, a unidirectional valve assembly 17 comprising a valve member 18, and an elastic member 19.

The battery part 15 includes elements that are capable of charging and discharging a battery. One side of the battery part 15 is coupled with the communication part 16, which is open to connect with the outside. The communication part 16 may take a variety of forms such as a hole, a tube, or a pipe. In addition, one side of the communication part 16 is coupled with the unidirectional valve assembly 17 for controlling, closing, and opening the communication part 16.

The unidirectional valve assembly 17 contains a valve member 18 that closes the communication part 16, an elastic member 19 that supports the valve member 18 by pressuring it, and a gas exit (not shown in the drawing) that releases gas at one side.

The battery part 15 repeats charging and discharging, leading to the generation of gas inside the battery, and an increase in the internal pressure thereof.

If the internal pressure of the battery part 15 rises to a predetermined level, a pressure force that is stronger than the force that is applied by the elastic member applies against the valve member 18. Accordingly, if the internal pressure of the battery part 15 rises to a predetermined level, the unidirectional valve assembly 17 opens to release the internal gas through the communication part 16.

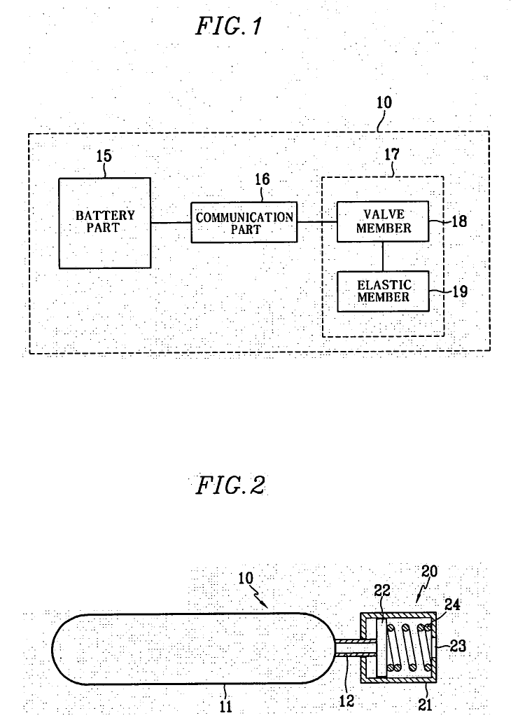

FIG. 2 is a cross-sectional view that schematically illustrates a pouch-shaped rechargeable battery according to a first embodiment of the present invention.

Referring to the FIG. 2, a rechargeable battery 10 of the present invention includes a case 11, a tube 12 that outwardly communicates with the case 11, and a unidirectional valve assembly 20 that is positioned at one side of the tube 12.

The unidirectional valve assembly 20 includes a housing that communicates with the tube 12 that is equipped on the case 11 and has an exit 23 that outwardly releases gas, and a valve member 22 that is positioned inside the housing 21 and closes the end of the tube 12 that communicates with the case 11. It also includes a compression spring 24 that is positioned between the housing 21 and the valve member 22 and applies pressure to the valve member 22 with a predetermined pressure.

The housing 21 supports the valve member 22 and the compression spring 25 installed therein and is not limited to a particular shape or size. The valve member 22 may be formed from rubber which has an intrinsically elastic force.

In addition, the compression spring 24 may be adapted to open the tube 12 by a very small increase in pressure inside the case. For example, the pressure applied to the valve member 22 may be about 0.01 atm to pressure higher than the atmospheric pressure. The compression spring 24 may be modified to have various structures other than the above spring structure. For example, materials with an intrinsic elastic force such as rubber and other alternative materials may be used.

If gas is generated in the pouch-shaped case 11 and its pressure increases beyond the atmospheric pressure by a predetermined value, the internal gas pressure in the case 11 pushes the valve member 22, thereby opening the tube 12. The gas released through the tube 12 passes through a gap between the housing 21 and the valve member 22 and then through an exit 23 that is formed on the housing 21, thereby decreasing the internal pressure in the case 11. The valve member 22 is pushed back to close the end of the tube 12 by the elastic force of the compression spring 24 and maintains an air-tight case 11 as the internal gas pressure in the tube 12 decreases.

As mentioned previously, if the internal pressure in the case 11 increases beyond a predetermined level, gases inside are automatically released to maintain the internal pressure of the case at a stable pressure level. Accordingly, the battery can always remain air-tight from the outside, and maintain its performance.

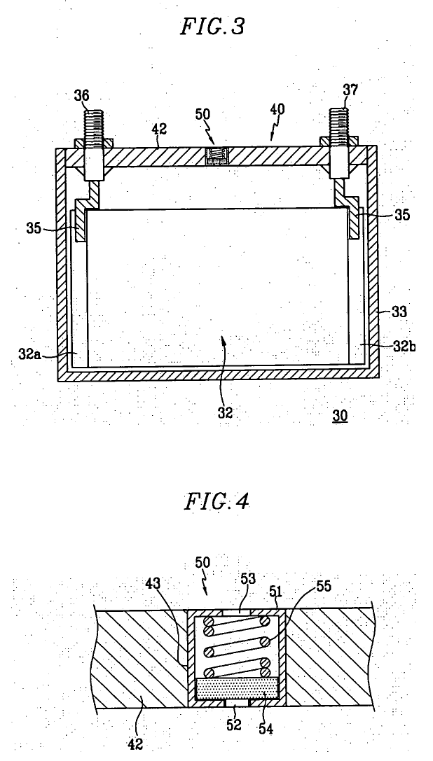

FIG. 3 and FIG. 4 illustrate a rechargeable battery according to a second embodiment of the present invention.

As shown in FIG. 3, a rechargeable battery 30 includes an electrode assembly 32 comprising a positive electrode and a negative electrode with a separator interposed therebetween, a rectangular-box case 33 with a space for housing the electrode assembly 32, and a cap assembly 40 that is mounted on the opening of the case 33 to close it tightly. In addition, a positive terminal 36 and a negative terminal 37 are coupled with the electrode assembly 32 through tabs 35 that protrude out of the cap assembly 40, and a unidirectional valve assembly 50 is installed on the cap assembly 40 to maintain the internal pressure of the battery.

The case 33 may comprise conductive metals such as aluminum, aluminum alloy, or nickel-plated steel, for example. Also, the case 33 may be formed as a hexagon with an internal space for housing the electrode assembly 32.

According to this embodiment of the present invention, the electrode assembly 32 is formed in a jelly-roll configuration by stacking a positive electrode and a negative electrode with a separator interposed therebetween and spirally winding them together.

Then the electrode assembly 32 is housed in the case 33, so that uncoated regions 32a and 32b are positioned opposite each other at both sides of the case 33 when the cap assembly 40 is positioned on top of the vertically positioned case 33. In addition, the uncoated regions 32a and 32b of the electrode assembly 32 are mounted with the tabs 35 (or current collecting plates) to couple the electrode terminals 36 and 37 to the electrode assembly 32.

The cap assembly 40 includes a cap plate 42 that is coupled with the upper end of the case 33 in an air-tight manner, positive terminal 36, and negative terminal 37. The terminals 36 and 37 are positioned on either sides of the cap plate 42 and are coupled with the uncoated regions 32a and 32b of the electrode assembly 32 through each tab 35 (or current collecting plate), respectively. As shown in FIG. 4, the cap plate 42 has an opening 43, and a unidirectional valve assembly 50 is installed in the opening 43.

The unidirectional valve assembly 50 includes a housing 51 that includes a hole 52 that communicates with the interior of the case therein and an exit 53 that also communicates with the outside and releases gas. The unidirectional valve assembly includes a valve member 54 that is installed to be able to move around in the housing 51 and to seal the hole 52, and a compression spring 55 that is installed between the valve member 54 and the housing 51 to compress the valve member 54.

Therefore, if the internal gas pressure applied against the valve member 54 through the hole 52 is stronger than the compressing force of the compression spring 55, the valve member 54 is pushed to open the hole 52. Then, the gas inside the case 33 is released through the open hole 52 and a gap between the valve member 54 and the housing 51 toward the exit 53. Accordingly, the internal gas released through the exit 53 out of the case 33 decreases the internal pressure inside the case 33.

The compressing force of the compression spring 55 against the valve member 54 determines the opening pressure of the valve member 54. Accordingly, a compression spring 55 with a small compressing force is preferred so that the valve member 54 can open when the internal pressure in the case 33 is at least 0.01 atm higher than the atmospheric pressure.

The elastic member, which applies an elastic force to the valve member 54, has no particular limits, and so any elastic member such as rubber other than the compression spring 55 may be used.

The valve member 54 may comprise synthetic resins such as rubbers and silicones which are intrinsically elastic in order to stably seal the hole 52.

If the internal pressure in the case 33 increases to a predetermined pressure level during the operation of the rechargeable battery, the unidirectional valve assembly 50 opens. As the unidirectional valve assembly 50 opens, it outwardly releases the gas from the inside of the case 33, and the internal pressure of the battery 30 is reduced back to its predetermined level. Then, the open valve member 54 moves back toward the hole 52 of the housing 51 to close it again. When the valve member 54 moves and closes up the hole 52, the case 33 can maintain its air-tight state by preventing external air from flowing into the case 33.

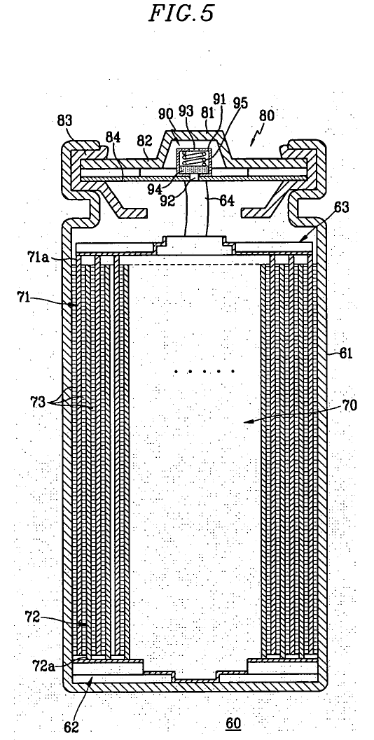

FIG. 5 shows a rechargeable battery according to a third embodiment of the present invention.

As shown in FIG. 5, a rechargeable battery 60 includes an electrode assembly 70 comprising a positive electrode 71, a negative electrode 72, a separator 73 interposed between the electrodes, a cylindrical case 61 for housing the electrode assembly 70, a cap assembly 80 that is mounted on the upper end of the opening of a case 61 through a gasket 83 that seals the case 61, and a unidirectional valve assembly 90 that is installed into the cap assembly 80 to stably maintain the internal pressure of the battery.

Here, the electrode assembly 70 is formed in a jelly-roll configuration by winding the two electrodes with a positive uncoated region 71a and a negative uncoated region 72a opposite each other at both ends of the electrode assembly 70 with a separator therebetween.

The electrode assembly 70 of an embodiment of the present invention is housed in the case 61 with the positive uncoated region 71a positioned at the upper end and the negative uncoated region 72a positioned at the bottom end when the case 61 is positioned vertically with the cap assembly 80 on top.

In addition, the negative uncoated region 72a is coupled with the case 61 through a negative current collecting plate 62. The positive uncoated region 71a is coupled with the cap assembly 80 through a positive current collecting plate 63 and a lead 64.

The cap assembly 80 includes a cap plate 82 that is coupled with the positive electrode 71 and has an outwardly protruding positive terminal 81, a gasket 83 that insulates the case 61 from a cap plate 82, and a vent plate 84 that is installed beneath the cap plate 82.

The vent plate 84 has a hole 92 in the center and is positioned inside the cap plate 82. In addition, the unidirectional valve assembly 90 is positioned in the center of the vent plate 84, and inside the positive terminal 81.

Furthermore, the positive terminal 81, which is formed on the cap plate 82, has a hole (not shown) on its surface that enables the internal gas of a battery to be released outward when the unidirectional valve assembly 90 is opened.

The unidirectional valve assembly 90 includes a housing 91 that contacts the cap plate 82 and the vent plate 84 installed therewith, an exit 93 to release gas at one side and a valve member 94 that is installed inside the housing 91 to close and open a hole 92, which penetrates the vent plate 84 and housing 91. In addition, an elastic spring 95 is installed between the housing 91 and valve member 94 and applies a set pressure to the valve member 94.

The valve member 94 opens and releases gas outwardly when the internal pressure of the battery increases and remains closed when the internal pressure of the battery is low. The valve member 94 may comprise elastic materials such as rubber.

FIG. 6 is a cross-sectional view of a safety valve assembly of a rechargeable battery according to a fourth embodiment of the present invention.

Referring to FIG. 6, a cap plate 42 has an opening 43 at one side and a unidirectional valve assembly 110 is formed in the opening 43. The unidirectional valve assembly 110 includes a hole 112 that communicates with the inside of the case. The external side of the unidirectional valve assembly includes a housing 111 that has an exit 113 that is open to the outside and releases gas, a valve member 114 that moves in the housing 111 to open and close up the hole 112, and an elastic member 115 which is installed between the valve member 114 and the housing 111 to compress the valve member 114.

According to this embodiment of the present invention, the elastic member 115 is formed from a synthetic resin such as rubber or silicone and is installed inside the housing in a compressed state and applies pressure on the valve member 114. The exit 113 is formed at an edge of the housing 111 to communicate with the inside of the housing 111.

Therefore, as the internal pressure in the case increases against the valve member 114, it shrinks the elastic member 115 and generates a space between the valve member 114 and the hole 112. Then, the internal gas in the case is released through the space out of the exit 113, thereby decreasing the internal pressure.

Then when the internal pressure in the case decreases below a predetermined level, the elastic member 115 applies pressure on the valve member 114 which closes the hole 112. Accordingly, the case 61 can maintain higher internal pressure than the atmospheric pressure, and the gas in the case flows only from the inside to the outside through the hole 112 but never in the opposite direction.

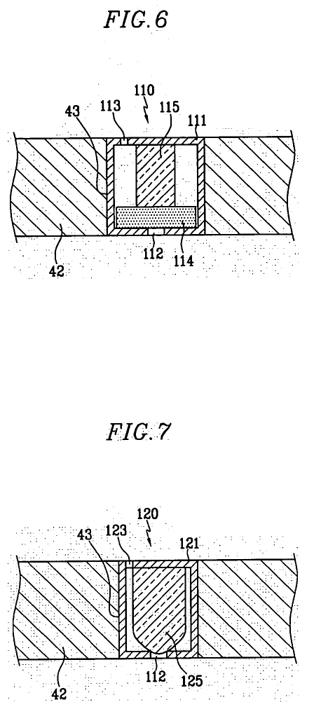

FIG. 7 is a cross-sectional view of a safety valve assembly of a rechargeable battery according to a fifth embodiment of the present invention.

Referring to FIG. 7, a cap plate 42 of the present invention has an opening 43 at one side and a unidirectional valve assembly 120 is formed at the opening.

The unidirectional valve assembly 120 includes a hole 112 that communicates with the inside of a case and an exit 123 that is formed on the exterior of a housing 121 and that is open to the outside and can release gas. The unidirectional valve assembly 120 also includes an elastic member 125 that is installed inside the housing 121 and that closes the hole 112.

According to the embodiment, the elastic member 125 is a unitary structure including both a valve member and an elastic member and functions to directly seal the hole. The elastic member 125 may include a synthetic resin such as rubber or silicone, and is installed in the housing 121 in a compressed state to seal the hole 112 by applying pressure. The elastic member 125 is formed as a structure that protrudes toward the hole 112. Accordingly, this compressed elastic member 125 may seal the hole 112 since its end is adapted to fit into the hole 112.

Furthermore, the exit 123 is formed at an edge of the housing 121 and communicates with the inside of the housing 121.

If the internal pressure in the case increases to apply pressure on the elastic member 125, the compressed elastic member 125 generates a space between the hole 112 and the elastic member 125. Then, the space becomes a passage through which the internal gas can be released out of the exit 123, thus decreasing the internal pressure inside the case.

In addition, when the internal pressure in the case decreases back to a predetermined level, the elastic member 125 is restored and closes up the hole 112. Accordingly, the case can always maintain a higher internal pressure than the atmospheric pressure so that gas flows from the inside to the outside of the case but not in the opposite direction.

The operation of a unidirectional valve assembly will be described with reference to a rectangular-box shaped battery as illustrated in FIG. 2 and FIG. 4.

The unidirectional valve assembly 50 is installed into a cap plate 42 to release gas to decrease the internal pressure of a case 33 due to gas that is generated in a battery during its operation.

The gas that is generated inside the case 33 applies pressure on a valve member 54 that seals a hole 52 of the housing 51. The valve member 54 keeps the hole 52 closed with the pressure of a compression spring 55, which is relatively stronger than the pressure of the gas.

However, if this internal gas pressure goes beyond a predetermined level, it overcomes the strength of the compression spring 55 and pushes the valve member 54 until it moves away from the hole 52. Once the hole 52 opens, the gas inside the case 33 escapes out of the housing 51 through the hole 52.

Finally, the gas inside the housing is released through an exit 53 that is formed in the housing 51.

As stated above, once the gas is outwardly released from the battery, the internal pressure of the case 33 decreases which decreases the gas pressure that pushes the valve member 54. Then, the valve member 54 seals the hole 52 again with the pressure of the compression spring 55. Thus, the unidirectional valve assembly 50 decreases the internal pressure of the battery while keeping the battery air-tight by closing the hole 52 to maintain the performance of the battery.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A rechargeable battery, comprising:
an electrode assembly comprising a positive electrode, a negative electrode, and a separator interposed therebetween;
a case for housing the electrode assembly; and
a unidirectional valve assembly that is installed at a side of the case
wherein the unidirectional valve assembly communicates with the inside of the case, and releases gas only from the inside to the outside.

2. The rechargeable battery of claim 1,
wherein the unidirectional valve assembly opens when the internal pressure of the rechargeable battery is higher than the external pressure thereof.

3. The rechargeable battery of claim 1,
wherein the unidirectional valve assembly opens when the internal pressure of the battery is about 0.01 atm higher than the external pressure thereof.

4. The rechargeable battery of claim 1,
wherein the unidirectional valve assembly comprises:
a housing formed to have a hole that communicates with a side of the case and an exit that releases gas at an other side;
a valve member positioned inside the housing that closes the hole that communicates with the case; and
an elastic member that is installed in between the housing and the valve member and that applies pressure to the valve member with a predetermined pressure.

5. The rechargeable battery of claim 4,
wherein the elastic member is a compression spring that is installed between the valve member and the inside of the housing.

6. The rechargeable battery of claim 4,
wherein the elastic member comprises rubber.

7. The rechargeable battery of claim 4,
wherein the valve member comprises an elastomer.

8. The rechargeable battery of claim 4,
wherein the valve member and the elastic member are formed as a unitary structure.

9. The rechargeable battery of claim 4,
wherein the case is formed as a pouch.

10. The rechargeable battery of claim 9,
wherein the housing comprises a tube that communicates with the inside of the pouch, and
wherein the valve member that is installed inside the housing closes up the end of the tube.

11. The rechargeable battery of claim 1,
wherein the battery is a lithium ion battery.

12. The rechargeable battery of claim 1,
wherein the battery is a lithium ion polymer battery.

13. The rechargeable battery of claim 1,
wherein the battery further comprises a cap assembly, which closes the case, and wherein the unidirectional valve assembly is positioned on the cap assembly.

14. The rechargeable battery of claim 13,
wherein the cap assembly comprises a cap plate that is coupled with the opening of the case in an air-tight manner, and
wherein the unidirectional valve assembly is mounted on the cap plate.

15. The rechargeable battery of claim 14,
wherein the cap assembly comprises:
the cap plate with an external terminal that protrudes outwardly;
a gasket that insulates the cap plate from the case; and
a vent plate that is positioned under the cap plate and has a hole in the center, and
the unidirectional valve assembly is installed in the center of the vent plate.

16. The rechargeable battery of claim 13,
wherein the case has a cylindrical shape.

17. The rechargeable battery of claim 13,
wherein the case has a rectangular-box shape.

18. The rechargeable battery of claim 14,
wherein the unidirectional valve assembly comprises:
a housing comprising a hole that communicates with the inside of the case at one side, and an exit that is open to the outside and releases gas at the other side,
a valve member that may move around in the housing to seal the hole, and
an elastic member that is positioned between the valve member and the housing to compress the valve member.

19. The rechargeable battery of claim 15,
wherein the unidirectional valve assembly is positioned inside a positive terminal and comprises:
a housing that includes an exit to release gas;
a valve member that is positioned inside the housing to close and open a hole that passes through the housing and the vent plate; and
an elastic member that is equipped between the housing and valve member and places a predetermined pressure on the valve member.

20. A motor-drive device, comprising the rechargeable battery of claim 1.
